(19) United States
(12) Patent Application Publication
(10) Pub. No.: US 2024/0377233 A1
(43) Pub. Date: Nov. 14, 2024

(54) Device for an Ultrasonic Flowmeter and Ultrasonic Flowmeter

(71) Applicant: Krohne AG, Basel (CH)

(72) Inventors: Jeroen Martin van Klooster, Tiel (NL); Arie Huijzer, Sliedrecht (NL)

(21) Appl. No.: 18/659,870

(22) Filed: May 9, 2024

(30) Foreign Application Priority Data
May 11, 2023 (DE) 10 2023 112 508.7

(51) Int. Cl. G01F 1/66

(52) U.S. Cl. CPC G01F 1/662

(57) ABSTRACT

A device includes a flow straightener insertable into a measuring tube of an ultrasonic flowmeter, a reflector device including a reflector body and an ultrasonic reflector on the reflector body, and a carrier having first and second carrier ends. The first carrier end is connected to the flow straightener. The second carrier end supports the reflector body. When the flow straightener is in the tube, the device is in an interior of the tube and the ultrasonic reflector deflects an ultrasonic measurement path emanating from the flowmeter so that the path extends through the interior along a longitudinal axis of the tube. The flow straightener has a first rotational symmetry about a first symmetry axis, and the carrier has a second rotational symmetry about a second symmetry axis. The first and second symmetry axes are coaxial. The ultrasonic reflector is spaced from the flow straightener along the second symmetry axis.

### TECHNICAL FIELD

In one aspect, the invention relates to a device for an ultrasonic flowmeter. The device has a flow straightener and a reflector device.

The ultrasonic flowmeter for which this device is intended comprises a measuring tube and an ultrasonic transducer. The measuring tube has a measuring tube interior and a longitudinal axis of the measuring tube. The ultrasonic transducer projects into the measuring tube interior.

The flow straightener is designed to be inserted into the measuring tube. The reflector device has a reflector body and an ultrasonic reflector arranged on the reflector body. The flow straightener and the reflector body are connected to each other.

When the flow straightener is inserted into the measuring tube of the ultrasonic transducer, the device is arranged inside the measuring tube. Further, the ultrasonic reflector redirects an ultrasonic measurement path originating from the ultrasonic transducer so that the ultrasonic measurement path also extends through the measuring tube interior along the longitudinal axis of the measuring tube.

Furthermore, the invention also relates to an ultrasonic flowmeter. The ultrasonic flowmeter has a measuring tube, an ultrasonic transducer, and a device.

The measuring tube has a measuring tube interior and a longitudinal axis of the measuring tube. The ultrasonic transducer projects into the measuring tube interior. The device has a flow straightener and a reflector device. The flow straightener is designed to be inserted into the measuring tube and is inserted into the measuring tube. The device is arranged in the measuring tube interior.

The reflector device has a reflector body and an ultrasonic reflector arranged on the reflector body. The flow straightener and the reflector body are connected to each other. The ultrasonic reflector deflects an ultrasonic measurement path emanating from the ultrasonic transducer so that the ultrasonic measurement path also extends through the measuring tube interior along the longitudinal axis of the measuring tube.

Thus, the flow straightener inserted into the measuring tube arranges the ultrasonic reflector in the measuring tube interior so that the ultrasonic measurement path, starting from the ultrasonic transducer, is deflected by the ultrasonic reflector in such a way that it extends through the measuring tube interior along the longitudinal axis of the measuring tube. The ultrasonic measurement path is bidirectional.

The ultrasonic transducer is designed to generate and radiate ultrasonic signals into a medium in the measuring tube interior. Usually, it is also designed to receive ultrasonic signals.

During operation of the ultrasonic flowmeter, the measuring tube interior is filled with a medium and the ultrasonic flowmeter measures a flow of the medium through the measuring tube interior. In the process, ultrasonic signals generated by the ultrasonic transducer and radiated into the medium propagate along the ultrasonic measurement path and are reflected by the ultrasonic reflector.

The ultrasonic transducer projecting into the measuring tube interior means that the ultrasonic transducer is in contact with the medium in the measuring tube interior. For this, the ultrasonic transducer can be arranged flush with a wall of the measuring tube, projecting beyond the wall of the measuring tube, or set back from the wall.

### BACKGROUND

Ultrasonic flowmeters of the type described, which are known from the prior art, basically have a further ultrasonic transducer in addition to the ultrasonic transducer and a further device in addition to the device. Such ultrasonic flowmeters thus have a further flow straightener, a further reflector device, a further reflector body and a further ultrasonic reflector, which are also designed as those previously described.

In such an ultrasonic flowmeter, for example, the ultrasonic transducer and the further ultrasonic transducer are arranged perpendicular to the longitudinal axis of the measuring tube. Accordingly, the reflector device and the further reflector device are arranged in the measuring tube interior such that the ultrasonic measurement path from the ultrasonic reflector and the further ultrasonic reflector are each deflected by 90°, whereby the ultrasonic measurement path also extends along the longitudinal axis of the measuring tube. There is only one single ultrasonic measurement path. Such an ultrasonic flowmeter is known, for example, from WO 2018/206536.

Ultrasonic flowmeters of the type described are used, for example, for flow measurement of fresh water as a medium in municipal water supply and in filling systems also for other media.

An important performance feature of ultrasonic flowmeters is a reproducibility of measurements of a constant flow of a medium through the measuring tube of an ultrasonic flowmeter. Repeatability is a measure of deviations between successive measurements under the same conditions. Equal conditions here include, in particular, the constant flow rate of the medium.

Studies of ultrasonic flowmeters known in the prior art have revealed a drawback. The device in such an ultrasonic flowmeter, even with a constant flow of a medium through the measuring tube, causes, on the one hand, asymmetrical constant disturbances and, on the other hand, transient disturbances in a flow of the medium, which negatively affect the reproducibility of measurements of the flow. The disturbances are especially turbulences.

In many applications, for example in municipal water supply, there is also the issue that a flow of a medium in the measuring tube has a high degree of turbulence. However, a high degree of turbulence is additionally detrimental to reproducibility.

### SUMMARY

The object of the present invention is to improve a reproducibility of measurements of a flow of a medium through the measuring tube of an ultrasonic flowmeter of the type described. In addition, the improvement is to be implementable at low cost and in a simple manner.

The object is achieved, on the one hand, by a device having the disclosed features. This device is characterized by the following features. The flow straightener has a first rotational symmetry about a first axis of symmetry. The device comprises a carrier having a first carrier end and a second carrier end, wherein the first carrier end is directly connected to the flow straightener and the second carrier end directly supports the reflector body. The carrier has a second rotational symmetry about a second axis of symmetry. The first axis of symmetry and the second axis of symmetry are coaxial with each other. The ultrasonic reflector has a reflector spacing from the flow straightener along the second axis of symmetry through the carrier.

Rotational symmetry is understood here to mean a symmetry that maps a three-dimensional body onto itself when the body is rotated about an axis of symmetry through an angle that is greater than 0° and less than 360°.

This device, when inserted into the ultrasonic flowmeter and during operation of the ultrasonic flowmeter, generates substantially rotationally symmetrical disturbances with respect to the first axis of symmetry in a flow of a medium in the region of the ultrasonic measurement path, wherein these disturbances are also substantially smaller than in prior art ultrasonic flowmeters. As a result, reproducibility of measurements of a flow of the medium through the ultrasonic flowmeter is significantly improved.

Some of the following designs of the device are necessarily described with reference to the ultrasonic flowmeter for which the device is intended, but which is not claimed in connection with the device.

In one design of the device, not only are the first axis of symmetry and the second axis of symmetry coaxial with each other, but also the longitudinal axis of the measuring tube and the first axis of symmetry are coaxial with each other. Due to the additional coaxiality of the longitudinal axis of the measuring tube to the two symmetry axes, the rotational symmetry in the disturbances in the flow of the medium through the measuring tube is further improved and these disturbances are also further reduced.

The reflector spacing is effected by the carrier. In another design, the carrier is rod-shaped, preferably with a circular cross-sectional area that is perpendicular to the second axis of symmetry. For example, the carrier is a rod. Such a carrier can be manufactured in a simple manner.

A medium flows around the carrier along the second axis of symmetry. Therefore, in a further design, it is provided that the carrier has a streamline shape for a low flow resistance of a medium. Preferably, the first carrier end is guided through the flow straightener and is rounded. Already this rounding of the first carrier end causes a streamline shape of the carrier, which reduces the flow resistance of the medium.

In another design, the reflector body has a reflector surface. The reflector surface and the second axis of symmetry span a reflector angle. The ultrasonic reflector is arranged on the reflector surface. The reflector angle is preferably between 115° and 155°, more preferably between 125° and 145°, and most preferably at 135°. If the reflector angle is at 135° and the ultrasonic transducer is arranged at an angle of 90°, i.e. perpendicular, to the measuring tube longitudinal axis, then the reflector device deflects the ultrasonic measuring path by 90°. A reflector angle other than 135° requires a corresponding angle of the ultrasonic transducer other than 90°. A smaller reflector angle than 135° causes a higher rotational symmetry of the reflector surface with respect to the second axis of symmetry. At a reflector angle of 90°, the reflector surface is rotationally symmetrical with respect to the second axis of symmetry, but the matching arrangement of the ultrasonic transducer is practically impossible. In a further embodiment, the reflector surface is the ultrasonic reflector.

In another design of the device, the reflector body has a third rotational symmetry about the second axis of symmetry. This third rotational symmetry causes a further reduction of disturbances in the flow of the medium.

In a device having the previously described reflector surface and the previously described third rotational symmetry, it is provided in one design that the reflector body comprises a wedge having a first wedge surface and a second wedge surface, that the first wedge surface and the second wedge surface oppose each other, and that the first wedge surface comprises the reflector surface. The third rotational symmetry is such that the wedge is imaged on itself when rotated 180° about the second axis of symmetry.

In another design of the device, the reflector body has a streamline shape for low flow resistance of a medium. Preferably, the streamline shape is implemented by a material having a low acoustic impedance applied to the reflector body. Preferably, the streamline shape will also have the third rotational symmetry about the second axis of symmetry described previously. For example, the reflector body does not exhibit the third rotational symmetry without the applied material and the third rotational symmetry is implemented only by the applied material. The acoustic impedance of the material is low with respect to a material of the reflector body, so that the ultrasonic reflector causes the deflection of the ultrasonic measurement path.

In another design, the reflector body is designed in the carrier itself at the second carrier end. This design of the device can be manufactured in a simple manner and at low cost. This applies in particular to a further development of this design in which the carrier is a rod and the reflector surface is designed in the rod itself. In this case, the reflector surface does not project laterally beyond the carrier.

In a further design, the ultrasonic reflector is made of a material having a high acoustic impedance. Preferably, the ultrasonic reflector is made of a metal and more preferably a stainless steel or an aluminum.

In another design alternative to the previously described design, the device is made of a material having a high acoustic impedance. Preferably it is made of a metal and particularly preferably it is made of a stainless steel or an aluminum.

Metals exhibit high acoustic impedance. Stainless steel and aluminum additionally exhibit good chemical properties with respect to many media, which includes, in particular, resistance. A high acoustic impedance ensures good reflection properties for ultrasonic signals generated by the ultrasonic transducer. A manufacture of the entire device from one material simplifies and reduces the cost thereof.

In a further design, at least one of the flow straightener, reflector body and carrier components is a casting or a 3D print. Thus, the device has the flow straightener, reflector body, and carrier components. Manufacturing one of the components as a casting is cost effective, and manufacturing one of the components as a 3D print allows for quick customization of features of the device.

In another design, at least two of the flow straightener, reflector body, and carrier components are one-piece and made from a single piece. The one-piece nature particularly improves the reliability of the at least two components by eliminating the need to join the two components.

In a further design, the flow straightener has a ring for insertion into the measuring tube and at least one guide vane for straightening the flow of a medium. Preferably, the flow straightener has at least two and particularly preferably at least three guide vanes. Furthermore, each of the at least one guide vane connects the ring and the carrier directly to each other. The guide vanes thus support the carrier. In a particularly preferred further development of this design, the carrier is a rod and the reflector body is designed at the second carrier end in the carrier itself. The use of more than one guide vane increases the stability of the arrangement of the carrier and reduces oscillation of the carrier. If more than one guide vane is present, then they are preferably arranged rotationally symmetrically with respect to the first axis of symmetry.

In an alternative design to the above design, the flow straightener is designed as a plate flow straightener. Compared to the flow straightener in the previously described design, the plate flow straightener provides better flow straightening. However, the price for this is a higher pressure loss of the flowing medium.

In another design, the flow straightener has a diameter and the reflector spacing is greater than half the diameter. This designation of the reflector spacing causes reduced disturbances of a flow of a medium at the reflector body.

The object is also achieved, on the other hand, by an ultrasonic flowmeter having the disclosed features. This ultrasonic flowmeter is characterized by the following features. The flow straightener has a first rotational symmetry about a first axis of symmetry. The device comprises a carrier having a first carrier end and a second carrier end. The first carrier end is directly connected to the flow straightener and the second carrier end directly supports the reflector body. The carrier has a second rotational symmetry about a second axis of symmetry. The first symmetry axis and the second symmetry axis are coaxial with each other. The ultrasonic reflector has a reflector spacing from the flow straightener along the second axis of symmetry through the carrier.

In one design of the ultrasonic flowmeter, the device is designed according to any of the previously described designs or further developments.

In one design, the measuring tube is divided along the longitudinal axis of the measuring tube into a first segment, a second segment, and a third segment. The third segment is adjacent to the first segment and the second segment is adjacent to the third segment. The first segment has a first diameter and the second segment has a second diameter. The first diameter is larger than the second diameter and a diameter of the third segment decreases from the first diameter at the first segment to the second diameter at the second segment. The flow straightener is inserted into the first segment. Accordingly, a diameter of the measuring tube tapers along the longitudinal axis of the measuring tube in the direction of flow of a medium through the measuring tube. Due to the tapering of the diameter of the measuring tube, disturbances in a flow of a medium in the second segment are reduced. For example, an advantageous ratio of the first diameter to the second diameter is about 2 to 1. Usually, the first and second diameters are constant along the longitudinal axis of the measuring tube.

In a further development of the previously described design, a measuring tube inner surface of the third segment has a shape of a truncated cone with a surface line. The surface line spans a taper angle with the longitudinal axis of the measuring tube. The taper angle is preferably between 5° and 15° and is most preferably 10°. These taper angles ensure that no boundary layer separation occurs at one end of the third segment in a medium flowing through the measuring tube. In principle, the taper angle is determined in such a way that boundary layer separation does not occur. Boundary layer separation creates recirculation vortices in the medium, which lead to a pressure drop in the medium.

If the measuring tube is divided into the three segments described above, then it is provided in one design that the ultrasonic transducer is perpendicular to the surface line and preferably flush with the measuring tube inner surface of the third segment. The ultrasonic transducer is thus arranged flush with a wall of the measuring tube. This arrangement of the ultrasonic transducer means that, on the one hand, there is no pocket in the wall of the measuring tube in which deposits could accumulate and, on the other hand, there are no structures which could cause disturbances in a flow of a medium in the measuring tube.

If the measuring tube is divided into the three segments described above, then in one design it is provided that the reflector device and the ultrasonic transducer are arranged in the third segment. As a result, the ultrasonic measurement path is substantially in the second segment, in which disturbances in a flow of a medium are reduced.

If the measuring tube is divided into the previously described three segments, then it is provided in a further design that the third segment and the reflector device form a minimum first flow cross-sectional area, that the second segment has a second flow cross-sectional area, and that the first flow cross-sectional area has a deviation from the second flow cross-sectional area of less than 10%, preferably less than 5%.

If the measuring tube is divided into the previously described three segments, then it is provided in a further design that an inner measuring tube surface of at least the second segment is lined with a material having a low acoustic impedance or at least the second segment is made of this material. Preferably, the material is a plastic. A low acoustic impedance attenuates reflections of ultrasonic signals. In the case of the measuring tube, this is desirable. This is because while ultrasonic signals propagate essentially along the longitudinal axis of the measuring tube, they also reach the inner wall of the measuring tube. However, reflections of ultrasonic signals from the inner wall interfere with a measurement of a flow of a medium through the measuring tube. The terms high and low in terms of acoustic impedance refer in particular to the acoustic impedance of a medium in the measuring tube.

In a further design of the ultrasonic flowmeter, the ultrasonic flowmeter comprises a further ultrasonic transducer extending into the measuring tube interior and a further device according to any of the previously described designs and further embodiments. Further, the ultrasonic measurement path extends from the ultrasonic transducer via the ultrasonic reflector through the measuring tube interior along the measuring tube longitudinal axis via the further ultrasonic reflector to the further ultrasonic transducer. Thus, the ultrasonic flowmeter with the further device has a further flow straightener, a further reflector device, a further reflector body and a further ultrasonic reflector.

In certain applications, a flow of a medium exhibits strong disturbances. In order to improve the reproducibility of measurements of a flow of the medium by the ultrasonic flowmeter, it is therefore preferably provided that the flow straightener is designed as a plate flow straightener and the further flow straightener is designed with guide vanes according to the previously described design.

In a further development of the previously described design, the measuring tube is mirror-symmetrical with respect to a mirror plane perpendicular to the longitudinal axis of the measuring tube. Further, the ultrasonic transducer and the further ultrasonic transducer are arranged mirror-symmetrically with respect to the mirror plane. Also, the device and the further device are arranged mirror-symmetrically to one another with respect to the mirror plane. As a result, the ultrasonic flowmeter is designed to measure a flow of a medium in both flow directions of the medium with a calibration for only one of the two directions.

If the ultrasonic flowmeter comprises the further device described above, then it is provided in one design that the device and the further device are designed to be the same.

In all other respects, the explanations for the device apply correspondingly to the ultrasonic flowmeter and vice versa.

### BRIEF DESCRIPTION OF THE DRAWINGS

In detail, there is a multitude of possibilities for designing and further developing the device for an ultrasonic flowmeter and the ultrasonic flowmeter. For this, reference is made both to the following description of preferred embodiments in conjunction with the drawings.

FIG. 1 illustrates a perspective view of an embodiment of an ultrasonic flowmeter with an embodiment of a device.

FIG. 2 illustrates a front view of the ultrasonic flowmeter.

FIG. 3 illustrates a sectional view of the ultrasonic flowmeter.

FIG. 4 illustrates a first perspective view of the embodiment of the ultrasonic flowmeter device.

FIG. 5 illustrates a second perspective view of the device.

FIG. 6 illustrates a front view of the device.

FIG. 7 illustrates a side view of the device.

### DETAILED DESCRIPTION

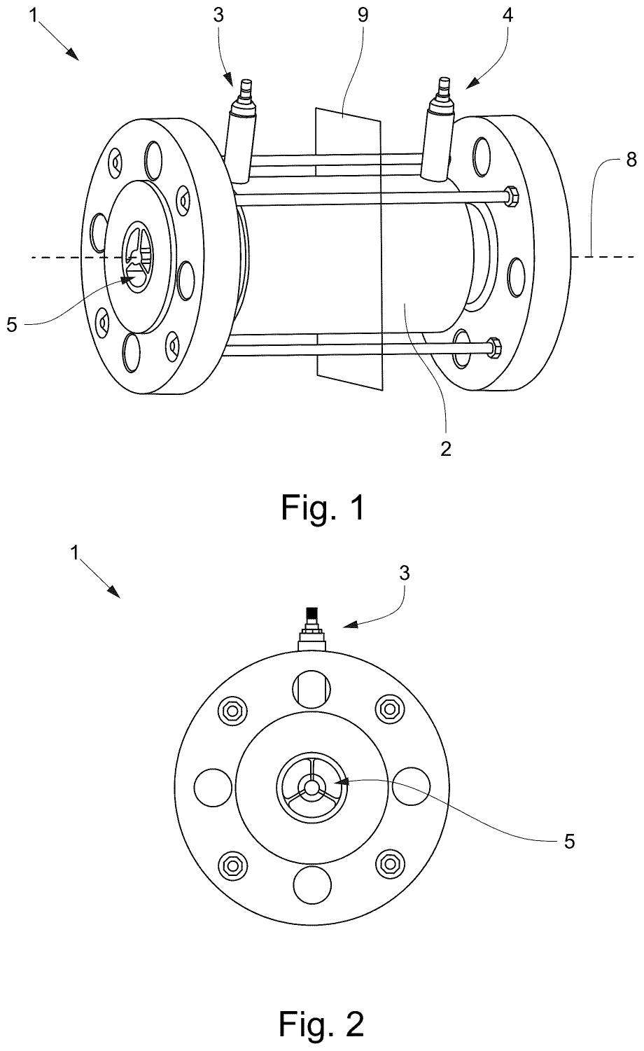

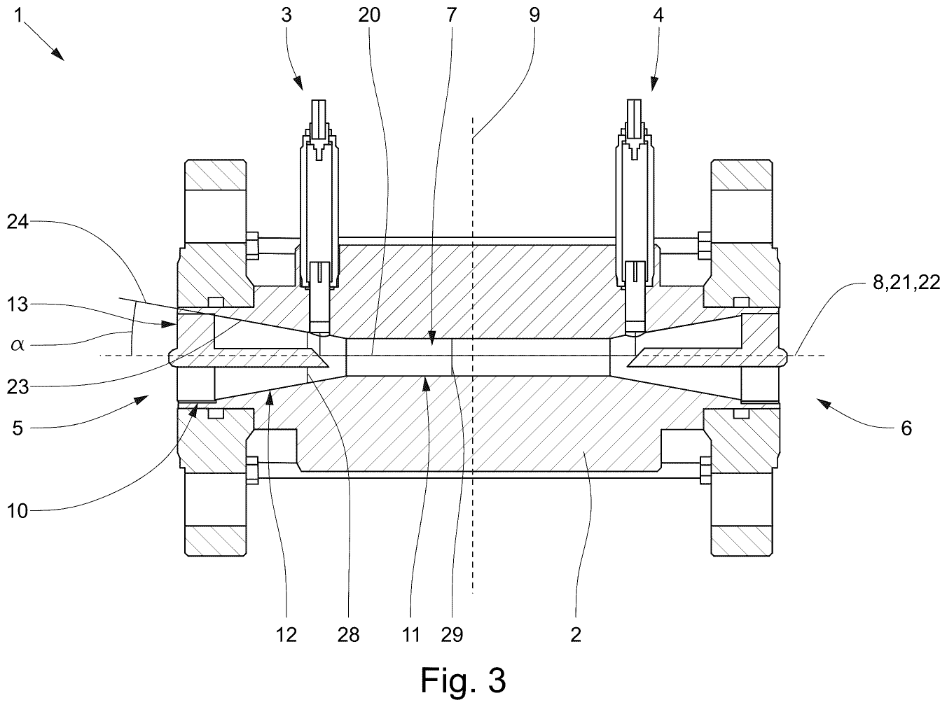

FIGS. 1, 2 and 3 show an embodiment of an ultrasonic flowmeter 1. The ultrasonic flowmeter 1 is shown in a perspective view in FIG. 1, in a front view in FIG. 2 and in a sectional view in FIG. 3.

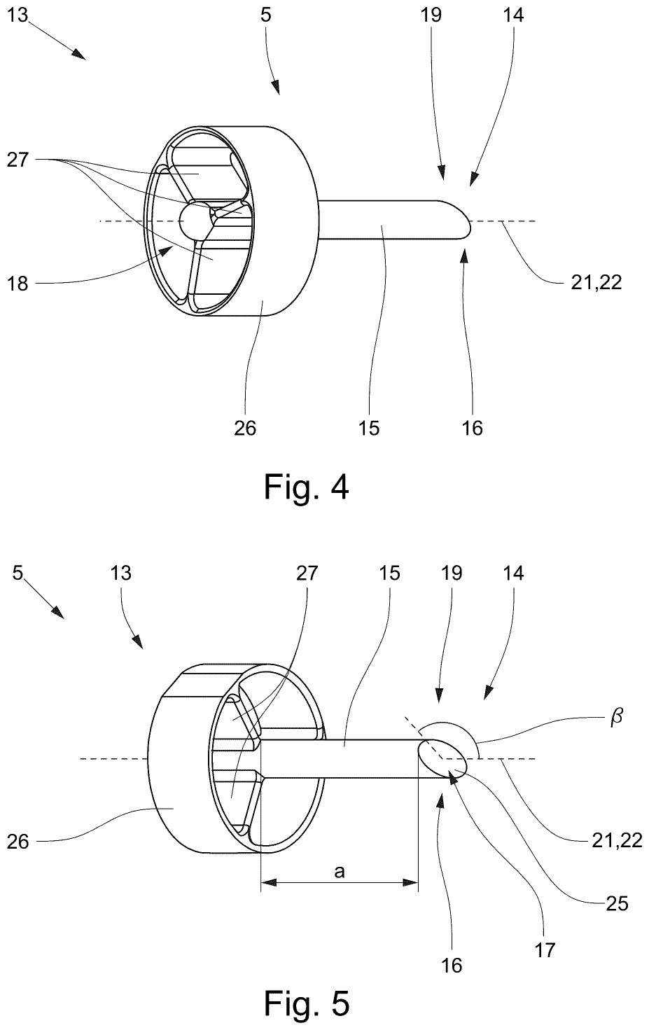

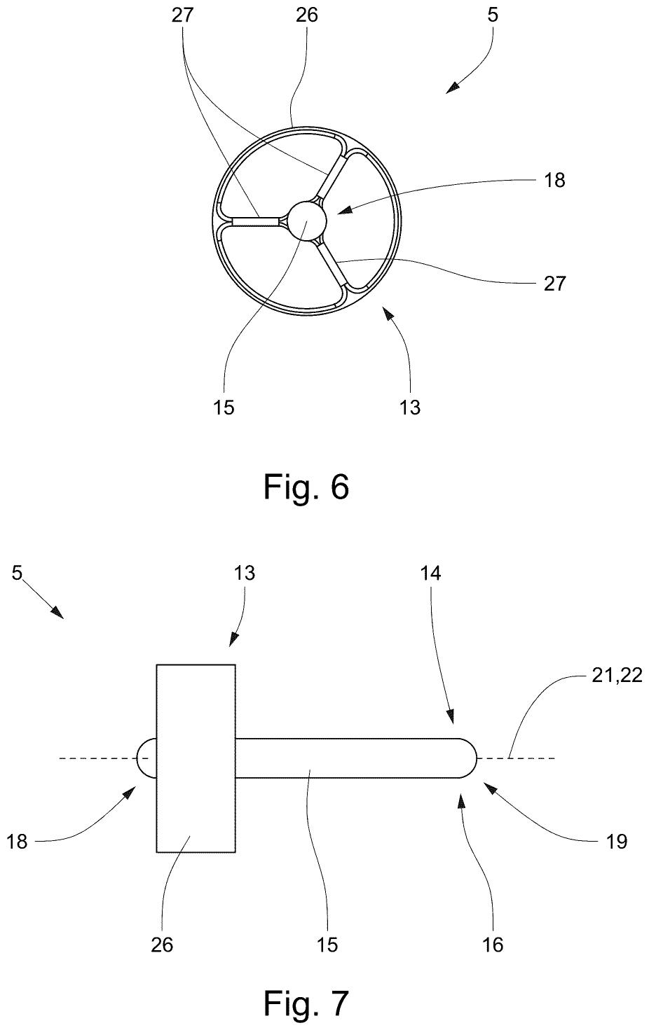

The ultrasonic flowmeter 1 has a measuring tube 2, an ultrasonic transducer 3 another ultrasonic transducer 4, a device 5 and another device 6. On the one hand, the ultrasonic transducer 3 and the further ultrasonic transducer 4 and, on the other hand, the device 5 and the further device 6 are identically designed. Therefore, the following explanations are basically limited to the ultrasonic transducer 3 and the device 5. The device 5 is shown in FIGS. 4, 5, 6 and 7. FIG. 4 shows a first and FIG. 5 a second perspective view, FIG. 6 a front view and FIG. 7 a side view of the device 5. The device 5 is integrally manufactured from a single piece of aluminum. In this embodiment, a stainless steel is chosen, since this has an even higher acoustic impedance than that of an aluminum.

The measuring tube 2 has a measuring tube interior 7 and a longitudinal axis 8 of the measuring tube and is mirror-symmetrical with respect to a mirror plane 9. The mirror plane 9 is perpendicular to the longitudinal axis 8 of the measuring tube. For this reason, the following explanations are limited in principle to the left half of the measuring tube 2. Further, on the one hand, the ultrasonic transducer 3 and the further ultrasonic transducer 4 and, on the other hand, the device 5 and the further device 6 are arranged mirror-symmetrically with respect to the mirror plane 9.

The left half of the measuring tube 2 is divided along the longitudinal axis 8 of the measuring tube into a first segment 10, a second segment 11 and a third segment 12. The third segment 12 is adjacent to the first segment 10 and the second segment 11 is adjacent to the third segment 12. The first segment 10 has a constant first diameter of 22 mm and the second segment 11 has a constant second diameter of 10 mm. The first diameter is larger than the second diameter and a diameter of the third segment 12 decreases from the first diameter at the first segment 10 to the second diameter at the second segment 11. The same applies to the right half of the measuring tube 2 due to mirror symmetry.

The ultrasonic transducer 3 projects into the measuring tube interior 7 and has an angle of 90° to the measuring tube longitudinal axis 8. It is therefore perpendicular to the measuring tube longitudinal axis 8.

The device 5 has a flow straightener 13, a reflector device 14 and a carrier 15. The flow straightener 13 is designed to be inserted into the measuring tube 2 and is inserted into the measuring tube 2.

The reflector device 14 has a reflector body 16 and an ultrasonic reflector 17 arranged on the reflector body 16.

The flow straightener 13 and the reflector body 16 are connected to each other by the carrier 15. The carrier 15 has a first carrier end 18 and a second carrier end 19. The first carrier end 18 is directly connected to the flow straightener 13, and the second carrier end 19 directly supports the reflector body 16.

The ultrasonic reflector 17 deflects an ultrasonic measurement path 20 emanating from the ultrasonic transducer 3, so that the ultrasonic measurement path 20 also extends through the measuring tube interior 7 along the longitudinal axis 8 of the measuring tube. The same applies to the right half of the flowmeter 1. Thus, the ultrasonic measurement path 20 extends from the ultrasonic transducer 3 via the ultrasonic reflector 17 of the device 5 through the measuring tube interior 7 along the longitudinal axis 8 of the measuring tube via the further ultrasonic reflector of the further device 6 to the further ultrasonic transducer 4. The ultrasonic measurement path is bidirectional.

The flow straightener 13 exhibits a first rotational symmetry about a first axis of symmetry 21. The carrier 15 exhibits a second rotational symmetry about a second axis of symmetry 22. The first axis of symmetry 21, the second axis of symmetry 22 and the measuring tube longitudinal axis 8 are coaxial with each other. The ultrasonic reflector 17 has a reflector spacing a from the flow straightener 13 along the second axis of symmetry 22 through the carrier 15.

A measuring tube inner surface 23 of the third segment 12 has a shape of a truncated cone with a surface line 24. The surface line 24 spans a taper angle α of 10° with the longitudinal axis 8 of the measuring tube.

The carrier 15 is a rod having a circular cross-sectional area. The first carrier end 18 is passed through the flow straightener 13 and is rounded, so that the carrier 15 has a streamline shape for low flow resistance of a medium.

The reflector body 16 is designed at the second carrier end 19 in the carrier 15 itself and has a reflector surface 25. The reflector surface 25 is laterally flush with the carrier 15, so it does not project beyond the carrier 15. The ultrasonic reflector 17 is the reflector surface 25 itself, since the aluminum has a sufficiently high acoustic impedance. The reflector surface 25 and the second axis of symmetry 21 span a reflector angle β of 135°. The ultrasonic reflector 17 is arranged on the reflector surface 25. Due to the vertical arrangement of the ultrasonic transducer 3 and the reflector angle β of 135°, the ultrasonic measurement path 20 emanating from the ultrasonic transducer 3 is deflected by 90° by the ultrasonic reflector 17 so that it runs parallel to the longitudinal axis 8 of the measuring tube.

The flow straightener 13 has a ring 26 for insertion into the measuring tube 2 and three guide vanes 27 for straightening a flow of a medium. Each of the guide vanes 27 directly connects the ring 26 and the carrier 15. The ring 26 is inserted into the first segment 10 of the measuring tube 2 and arranges the reflector device 14 in the third segment 12. The ultrasonic transducer 3 is also arranged in the third segment 12.

The third segment 12 and the reflector device 14, more precisely the carrier 15, form a minimum first flow cross-sectional area 28 and the second segment 11 has a second flow cross-sectional area 29 for a medium flowing through the measuring tube 2. The minimum first flow cross-sectional area 28 is as large as the second flow cross-sectional area 29. The first flow cross-sectional area 28 decreases with the diameter of the third segment 12. The minimum first flow cross-sectional area 28 is relevant here.

1. A device for an ultrasonic flowmeter, the ultrasonic flowmeter including a measuring tube having a measuring tube interior and a longitudinal axis, and an ultrasonic transducer projecting into the measuring tube interior, the device comprising:
a flow straightener is designed to be inserted into the measuring tube;
a reflector device including a reflector body and an ultrasonic reflector arranged on the reflector body; and
a carrier having a first carrier end and a second carrier end;
wherein the flow straightener and the reflector body are connected to each other;
wherein, when the flow straightener is inserted into the measuring tube, the device is arranged in the measuring tube interior and the ultrasonic reflector deflects an ultrasonic measurement path emanating from the ultrasonic transducer so that the ultrasonic measurement path also extends through the measuring tube interior along the longitudinal axis of the measuring tube;
wherein the flow straightener has a first rotational symmetry about a first axis of symmetry;
wherein the first carrier end is directly connected to the flow straightener and the second carrier end directly supports the reflector body;
wherein the carrier has a second rotational symmetry about a second axis of symmetry;
wherein the first axis of symmetry and the second axis of symmetry are coaxial to each other; and
wherein the ultrasonic reflector has a reflector spacing from the flow straightener along the second axis of symmetry by the carrier.

2. The device according to claim 1, wherein the longitudinal axis of the measuring tube and the first axis of symmetry are coaxial with each other.

3. The device according to claim 1, wherein the carrier is rod-shaped.

4. The device according to claim 1, wherein the carrier has a streamline shape for low flow resistance of a medium; and
wherein the first carrier end extends through the flow straightener and is rounded.

5. The device according to claim 1, wherein the reflector body has a reflector surface;
wherein the reflector surface and the second axis of symmetry span a reflector angle;
wherein the ultrasonic reflector is arranged on the reflector surface; and
wherein the reflector angle is between 115° and 155°.

6. The device according to claim 1, wherein the reflector body has a third rotational symmetry about the second axis of symmetry.

7. The device according to claim 5, wherein the reflector body includes a wedge having a first wedge surface and a second wedge surface;
wherein the first wedge surface and the second wedge surface are opposite to each other; and
wherein the first wedge surface includes the reflector surface.

8. The device according to claim 1, wherein the reflector body has a streamline shape for a low flow resistance of a medium; and
wherein the streamline shape is implemented by a material having a low acoustic impedance applied to the reflector body.

9. The device according to claim 1, wherein the reflector body at the second carrier end is designed in the carrier itself.

10. The device according to claim 1, wherein the ultrasonic reflector is made of a metal material with a high acoustic impedance.

11. The device according to claim 1, wherein the device is made of a metal material with a high acoustic impedance.

12. The device according to claim 1, wherein at least one of the flow straightener, the reflector body, and the carrier is a casting or a 3D print.

13. The device according to claim 1, wherein at least two of the flow straightener, the reflector body, and the carrier are made integrally and from a single piece.

14. The device according to claim 1, wherein the flow straightener includes a ring for insertion into the measuring tube and at least one guide vane directly connected to the ring and the carrier.

15. The device according to claim 1, wherein the flow straightener is designed as a plate flow straightener.

16. The device according to claim 1, wherein the flow straightener has a diameter and the reflector spacing is greater than half the diameter.

17. An ultrasonic flowmeter, comprising:
a measuring tube having a measuring tube interior and a longitudinal axis of the measuring tube, an ultrasonic transducer projecting into the measuring tube interior; and
a device having a flow straightener, a reflector device, and a carrier;
wherein the flow straightener is designed for insertion into the measuring tube and is inserted into the measuring tube;
wherein the device is arranged in the measuring tube interior;
wherein the reflector device includes a reflector body and an ultrasonic reflector arranged on the reflector body;
wherein the flow straightener and the reflector body are connected to each other;
wherein the ultrasonic reflector deflects an ultrasonic measurement path emanating from the ultrasonic transducer so that the ultrasonic measurement path also extends through the measuring tube interior along the longitudinal axis of the measuring tube;
wherein the flow straightener has a first rotational symmetry about a first axis of symmetry;
wherein the carrier has a first carrier end and a second carrier end, and the first carrier end is directly connected to the flow straightener and the second carrier end directly supports the reflector body;
wherein the carrier has a second rotational symmetry about a second axis of symmetry;
wherein the first axis of symmetry and the second axis of symmetry are coaxial to each other; and
wherein the ultrasonic reflector has a reflector spacing from the flow straightener along the second axis of symmetry by the carrier.

18. The ultrasonic flowmeter according to claim 17, wherein the device is designed such that at least one of:
the longitudinal axis of the measuring tube and the first axis of symmetry are coaxial with each other;
the carrier is rod-shaped;
the carrier has a streamline shape for low flow resistance of a medium, and the first carrier end extends through the flow straightener and is rounded;
the reflector body has a reflector surface, the reflector surface and the second axis of symmetry span a reflector angle, the ultrasonic reflector is arranged on the reflector surface, and the reflector angle is between 115° and 155°:
the reflector body has a third rotational symmetry about the second axis of symmetry:
the reflector body includes a wedge having a first wedge surface and a second wedge surface, the first wedge surface and the second wedge surface are opposite to each other, and the first wedge surface includes the reflector surface;
the reflector body has a streamline shape for a low flow resistance of a medium, and the streamline shape is implemented by a material having a low acoustic impedance applied to the reflector body;
the reflector body at the second carrier end is designed in the carrier itself;
the ultrasonic reflector is made of a metal material with a high acoustic impedance;
the device is made of a metal material with a high acoustic impedance;
at least one of the flow straightener, the reflector body, and the carrier is a casting or a 3D print;
at least two of the flow straightener, reflector body and carrier components are made integrally and from a single piece;
the flow straightener includes a ring for insertion into the measuring tube and at least one guide vane directly connected to the ring and the carrier;
the flow straightener is designed as a plate flow straightener; and
the flow straightener has a diameter and the reflector spacing is greater than half the diameter.

19. The ultrasonic flowmeter according to claim 17, wherein the measuring tube is divided along the longitudinal axis of the measuring tube into a first segment, a second segment and a third segment;
wherein the third segment is adjacent to the first segment and the second segment is adjacent to the third segment;
wherein the first segment has a first diameter and the second segment has a second diameter;
wherein the first diameter is larger than the second diameter and that a diameter of the third segment decreases from the first diameter at the first segment to the second diameter at the second segment; and
wherein the flow straightener is inserted into the first segment.

20. The ultrasonic flowmeter according to claim 19, wherein a measuring tube inner surface of the third segment has a shape of a truncated cone with a surface line;
wherein the surface line spans a taper angle with the longitudinal axis of the measuring tube; and
wherein the taper angle is between 5° and 15°.

21. The ultrasonic flowmeter according to claim 20, wherein the ultrasonic transducer is perpendicular to the surface line and terminates flush with the measuring tube inner surface of the third segment.

22. The ultrasonic flowmeter according to claim 19, wherein the reflector device and the ultrasonic transducer are arranged in the third segment.

23. The ultrasonic flowmeter according to claim 19, wherein the third segment and the reflector device form a minimum first flow cross-sectional area; and
wherein the second segment has a second flow cross-sectional area and the first flow cross-sectional area has a deviation from the second flow cross-sectional area of less than 10%.

24. The ultrasonic flowmeter according to claim 19, wherein a measuring tube inner surface of at least the second segment is lined with a plastic material having a low acoustic impedance or at least the second segment is made of said plastic material.

25. The ultrasonic flowmeter according to claim 17, wherein the ultrasonic flowmeter has a further ultrasonic transducer projecting into the measuring tube interior and a further device that includes:
a flow straightener designed to be inserted into the measuring tube;
a reflector device including a reflector body and an ultrasonic reflector arranged on the reflector body; and
a carrier having a first carrier end and a second carrier end;
wherein the flow straightener and the reflector body are connected to each other:
wherein, when the flow straightener is inserted into the measuring tube, the device is arranged in the measuring tube interior and the ultrasonic reflector deflects an ultrasonic measurement path emanating from the ultrasonic transducer so that the ultrasonic measurement path also extends through the measuring tube interior along the longitudinal axis of the measuring tube;
wherein the flow straightener has a first rotational symmetry about a first axis of symmetry;
wherein the first carrier end is directly connected to the flow straightener and the second carrier end directly supports the reflector body;
wherein the carrier has a second rotational symmetry about a second axis of symmetry;
wherein the first axis of symmetry and the second axis of symmetry are coaxial to each other; and
wherein the ultrasonic reflector has a reflector spacing from the flow straightener along the second axis of symmetry by the carrier; and
wherein the ultrasonic measurement path extends from the ultrasonic transducer via the ultrasonic reflector through the measuring tube interior also along the longitudinal axis of the measuring tube via the further ultrasonic reflector to the further ultrasonic transducer.

26. The ultrasonic flowmeter according to claim 25, wherein the measuring tube is mirror-symmetrical with respect to a mirror plane perpendicular to the longitudinal axis of the measuring tube; and
wherein, on the one hand, the ultrasonic transducer and the further ultrasonic transducer and, on the other hand, the device and the further device are each arranged mirror-symmetrically with respect to the mirror plane.

27. The ultrasonic flowmeter according to claim 25, wherein the device and the further device are designed identically.
